(19) United States
(12) Patent Application Publication
(10) Pub. No.: US 2022/0291874 A1
(43) Pub. Date: Sep. 15, 2022

(54) DATA INTEGRITY CHECKING MECHANISM FOR SHARED EXTERNAL VOLUME

(71) Applicant: Hitachi, Ltd., Tokyo (JP)

(72) Inventors: Naruki KURATA, San Jose, CA (US); Tomohiro KAWAGUCHI, Santa Clara, CA (US)

(73) Assignee: Hitachi, Ltd.

(21) Appl. No.: 17/201,832

(22) Filed: Mar. 15, 2021

(51) Int. Cl. G06F 3/06

(52) U.S. Cl. CPC G06F 3/0664; G06F 3/0659; G06F 3/0647; G06F 3/0619; G06F 3/0679

(57) ABSTRACT

Example implementations described herein involve systems and methods which can include managing a mapping between write identifier, access virtual device identifier, and physical device for a drive unit comprising a plurality of physical devices. for migration of a virtual device from a first controller to a second controller, example implementations can further involve retrieving a virtual device identifier from the second controller; determining the physical device associated with the virtual device from the plurality of physical devices; and updating, for the determined physical device, the access virtual device identifier with the virtual device identifier in the mapping. Commands received to the determined physical device are processed through modification of one or more fields related to a data integrity field of the commands based on the updated mapping. Data received from the determined physical device is processed through modification of the data integrity field based on the updated mapping.

### BACKGROUND

### Field

The present disclosure is generally directed to storage systems, and more specifically, to data integrity checking mechanisms for shared external volumes.

### Related Art

In the related art, solid state drives (SSDs) are used for Information Technology (IT) platform systems because of its high capacity and performance. As SSDs have high capacity and performance, the processing performance of Central Processing Units (CPUs) in a storage controller may be unable to keep up with these resources and they are underutilized. To utilize the resources, one related art solution involves chunking SSDs. Chunking SSDs can involve showing each chunk as a virtual device and sharing these virtual devices among multiple storage controllers.

In the related art, there are compound storage systems that shares a drive unit among different controllers. Such storage systems can change an ‘owner’ of a virtual device from a storage controller to another storage controller by transferring metadata of the virtual device while the data on the drive unit stays where it is (hereinafter referred to as ‘migration’). This technique facilitates faster migration than just copying all the data to change the owner.

Another technique in some storage interface specification such as Small Computer Systems Interface (SCSI) or Non-Volatile Memory Express (NVMe) that realize “end-to-end data protection” by using Data Integrity Field (DIF). DIF consists of 2 bytes of Guard Tag, 2 bytes of Application Tag and 4 bytes of Reference Tag. Generally, a Guard Tag is a 16-bit CRC (Cyclic Redundancy Check code) of the 512-byte user data. The Application Tag is an application client specific information and the Reference Tag is the lower 4-bytes of the logical block address (LBA). In some cases, a device specific identifier is used as an Application Tag to make sure that proper device is used for the storage controller.

### SUMMARY

When combining migration features and DIF end-to-end data protection, an inconsistency may happen in some situations. First, as (virtual) device specific identifiers (VDEV IDs) are managed by each storage controller, when migrating a virtual device, a VDEV ID conflict may occur if the metadata is naively copied. Therefore, the storage controller that receives metadata finds a new VDEV ID and applies it to the migrated metadata. On the other hand, the corresponding data that is written in the drive has a DIF with the old VDEV ID as the Application Tag. Therefore, despite the successful migration, an Application Tag check error occurs when checking the Application Tag with the new VDEV ID. One solution for this is to overwrite all Application Tags stored in the drive to the new VDEV ID. However, this takes more time than just copying the data, which defeats the purpose of metadata migration.

Aspects of the present disclosure can involve a method, which can involve managing a mapping between write identifier, access VDEV ID, and physical device for a drive unit comprising a plurality of physical devices; for migration of a virtual device from a first controller to a second controller, retrieving a new VDEV ID from the second controller; determining the physical device associated with the virtual device from the plurality of physical devices; and updating, for the determined physical device, the access VDEV ID with the new VDEV ID in the mapping; wherein a command received from the second controller to the determined physical device is processed through modification of one or more fields related to a data integrity field of the command based on the updated mapping; and data received from the determined physical device to the second controller is processed through modification of the data integrity field of the data based on the updated mapping.

Aspects of the present disclosure can involve a computer program, which can involve instructions involving managing a mapping between write identifier, access VDEV ID, and physical device for a drive unit comprising a plurality of physical devices; for migration of a virtual device from a first controller to a second controller, retrieving a new VDEV ID from the second controller; determining the physical device associated with the virtual device from the plurality of physical devices; and updating, for the determined physical device, the access VDEV ID with the new VDEV ID in the mapping; wherein a command received from the second controller to the determined physical device is processed through modification of one or more fields related to a data integrity field of the command based on the updated mapping; and data received from the determined physical device to the second controller is processed through modification of the data integrity field of the data based on the updated mapping. The instructions can be stored in a non-transitory computer readable medium and executed by one or more processors.

Aspects of the present disclosure can involve a system, which can involve means for managing a mapping between write identifier, access VDEV ID, and physical device for a drive unit comprising a plurality of physical devices; for migration of a virtual device from a first controller to a second controller, means for retrieving a new VDEV ID from the second controller; means for determining the physical device associated with the virtual device from the plurality of physical devices; and means for updating, for the determined physical device, the access VDEV ID with the new VDEV ID in the mapping; wherein a command received from the second controller to the determined physical device is processed through modification of one or more fields related to a data integrity field of the command based on the updated mapping; and data received from the determined physical device to the second controller is processed through modification of the data integrity field of the data based on the updated mapping.

Aspects of the present disclosure can involve an apparatus, which can involve a memory configured to manage a mapping between write identifier, access VDEV ID, and physical device for a drive unit comprising a plurality of physical devices; and a processor, configured to, for migration of a virtual device from a first controller to a second controller, retrieve a new VDEV ID from the second controller; determine the physical device associated with the virtual device from the plurality of physical devices; and update, for the determined physical device, the access VDEV ID with the new VDEV ID in the mapping; wherein a command received from the second controller to the determined physical device is processed through modification of one or more fields related to a data integrity field of the command based on the updated mapping; and data received from the determined physical device to the second controller is processed through modification of the data integrity field of the data based on the updated mapping.

### BRIEF DESCRIPTION OF DRAWINGS

FIG. 1 illustrates an example implementation of a computer system.

FIG. 2 illustrates a logical storage configuration of the computer system, in accordance with an example implementation.

FIG. 3 illustrates an example logical storage configuration when metadata migration occurs from the state of FIG. 2.

FIG. 4 illustrates a data layout of a logical block with Data Integrity Field, in accordance with an example implementation.

FIG. 5 illustrates a write command sent from a storage controller to a drive unit, in accordance with an example implementation.

FIG. 6 illustrates a read command sent from a storage controller to a drive unit, in accordance with an example implementation.

FIG. 7 illustrates a migrate command sent from a storage controller to a drive unit, in accordance with an example implementation.

FIG. 8 illustrates an example of a device mapping table, in accordance with an example implementation.

FIG. 9 illustrates an example of an access VDEV Table, in accordance with an example implementation.

FIG. 10 illustrates an example of a flow diagram in which a drive unit processes a write command and its corresponding data from a storage controller in accordance with an example implementation.

FIG. 11 illustrates an example of a flow diagram in which a drive unit processes a read command from a storage controller, in accordance with an example implementation.

FIG. 12 illustrates an example of a flow diagram in which a drive unit receives a read data from a PDEV, in accordance with an example implementation.

FIG. 13 illustrates an example of a flow diagram when a drive unit receives a migration command from a storage controller, in accordance with an example implementation.

FIG. 14 illustrates an example overview of a data write process, in accordance with an example implementation.

FIG. 15 illustrates an example overview of a data read process, in accordance with an example implementation.

FIG. 16 illustrates a logical storage configuration when metadata replication occurs from the state of FIG. 2, in accordance with an example implementation.

FIG. 17 illustrates an example of an enhanced access VDEV Table, in accordance with an example implementation.

FIG. 18 illustrates an example of a replicate command, in accordance with an example implementation.

FIG. 19 illustrates an example of a flow diagram when a drive unit receives a replicate command from a storage controller, in accordance with an example implementation.

FIG. 20 shows an example overview of two data read processes, in accordance with an example implementation.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations.

The following example implementations illustrate computer systems which provide end-to-end data integrity checking feature and volume migration feature using storage medium sharing capability as a form of storage controller and drive unit.

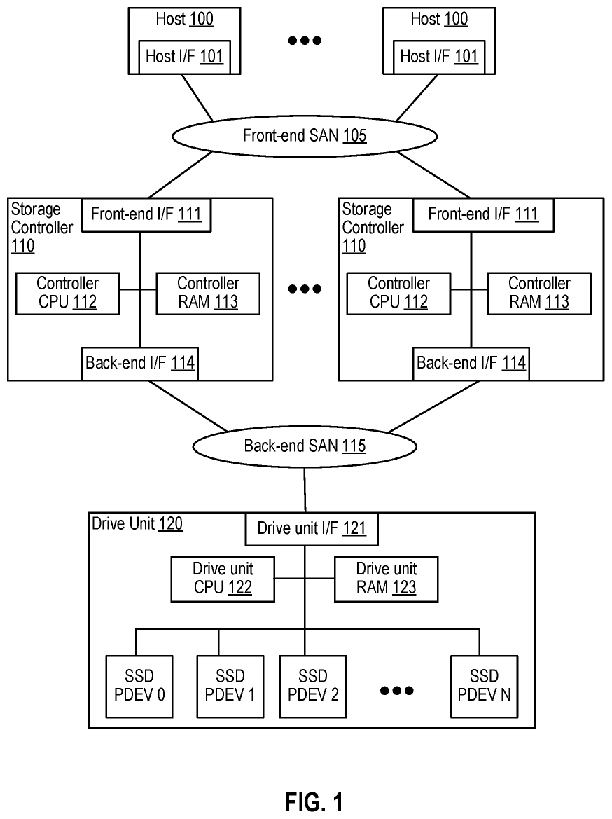

FIG. 1 illustrates an example implementation of a computer system. The computer system can involve one or more hosts 100, one or more storage controllers 110 and a drive unit 120. The hosts 100 are connected to the storage controllers 110 via a front-end Storage Area Network (SAN) 105. The drive unit 120 is connected to the storage controllers 110 via a back-end SAN 115.

A host 100 is a computer that runs user application programs. The host connects to the storage controllers via the front-end SAN 105 through a host interface (I/F) 101 and accesses the storage area provided by the storage controllers 110. The host 100 requests the storage controllers 110 to store and retrieve data to/from SSDs (PDEV 0, PDEV 1, . . . ) in the drive unit 120.

In this example implementation, SSDs are used as data storage medium, but they can be hard disk drives or other storage medium in accordance with the desired implementation, although the mechanism is more effective against SSDs.

A storage controller 110 can include a front-end I/F 111, a controller CPU 112, a controller random access memory (RAM) 113, and a back-end I/F 114. The front-end I/F 111 is an interface that communicates with hosts via the front-end SAN 105. The back-end I/F 114 is an interface that communicates with drive unit 120 via the back-end SAN 115. The controller RAM 113 includes an area where a program and metadata used by the controller CPU 112 to control the storage controller is stored, and a cache memory area where data is temporarily stored. The controller RAM 113 can be a volatile medium or a non-volatile medium depending on the desired implementation.

A drive unit 120 includes a drive unit I/F 121, a drive unit CPU 122 and a drive unit RAM 123. The drive unit I/F 121 is an interface that communicate with storage controllers 110 via the back-end SAN 115. The drive unit RAM 123 includes an area where a program and metadata used by the drive unit CPU 122 to control the drive unit is stored, and a cache memory area where data is temporarily stored. The drive unit RAM 123 can be a volatile medium or a non-volatile medium.

In this example implementation, the front-end SAN 105 and the back-end SAN 115 are physically separated networks, but they can be logically separated networks (e.g. virtual local area network or VLAN), or can be the same network depending on the desired implementation.

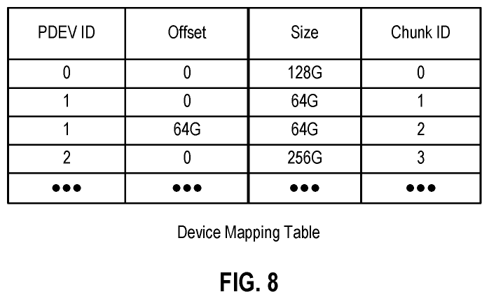

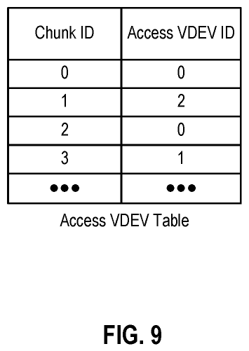

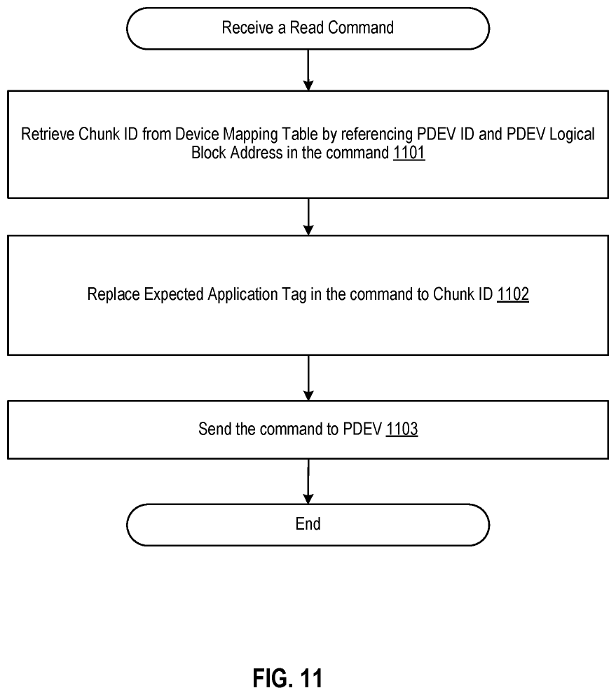

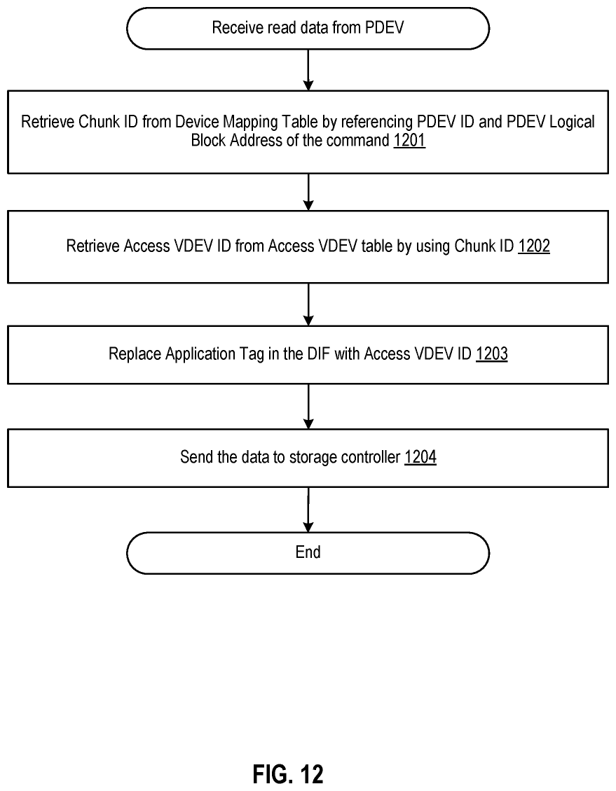

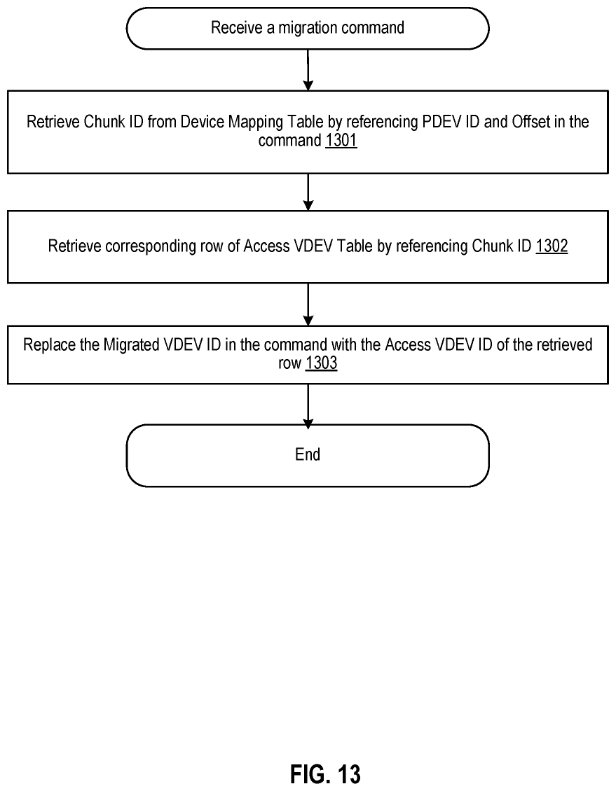

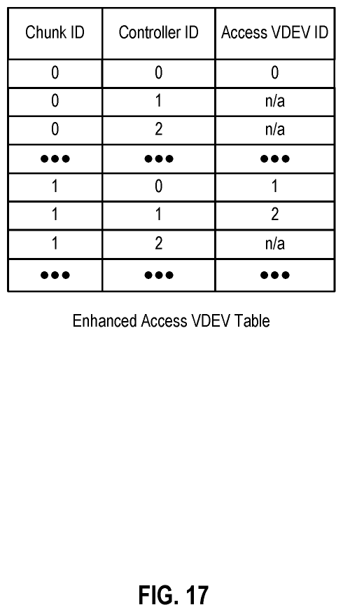

Depending on the desired implementation, RAM 113 or RAM 123 can be configured to manage a mapping between write identifier, access VDEV ID, and physical device for a drive unit involving a plurality of physical devices as illustrated in FIG. 8, FIG. 9 and FIG. 17. CPU 112 or CPU 122 can be configured to, for migration of a virtual device from a first controller to a second controller, retrieve a new VDEV ID from the second controller; determine the physical device associated with the virtual device from the plurality of physical devices; and update, for the determined physical device, the access VDEV ID with the new VDEV ID in the mapping, as illustrated in FIG. 13. Depending on the desired implementation, a command received from the second controller to the determined physical device is processed through modification of one or more fields related to a data integrity field of the command based on the updated mapping as illustrated in FIG. 11; and data received from the determined physical device to the second controller is processed through modification of the data integrity field of the data based on the updated mapping as illustrated in FIG. 12.

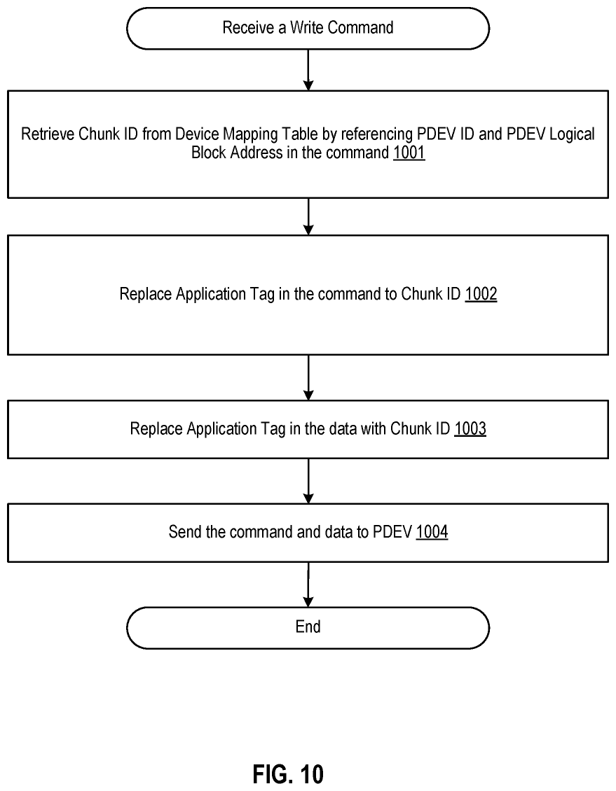

CPU 112 or CPU 122 can be configured to modify the one or more fields related to the data integrity field of the command according to the write identifier to form a modified command; and transmitting the modified command to the determined physical device as illustrated in FIG. 10.

CPU 112 or CPU 122 can be configured to modify the data integrity field of received data directed to the second controller with the access VDEV ID to form modified data; and transmitting the modified data to the second controller as illustrated in FIG. 12.

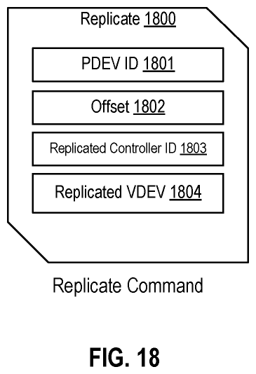

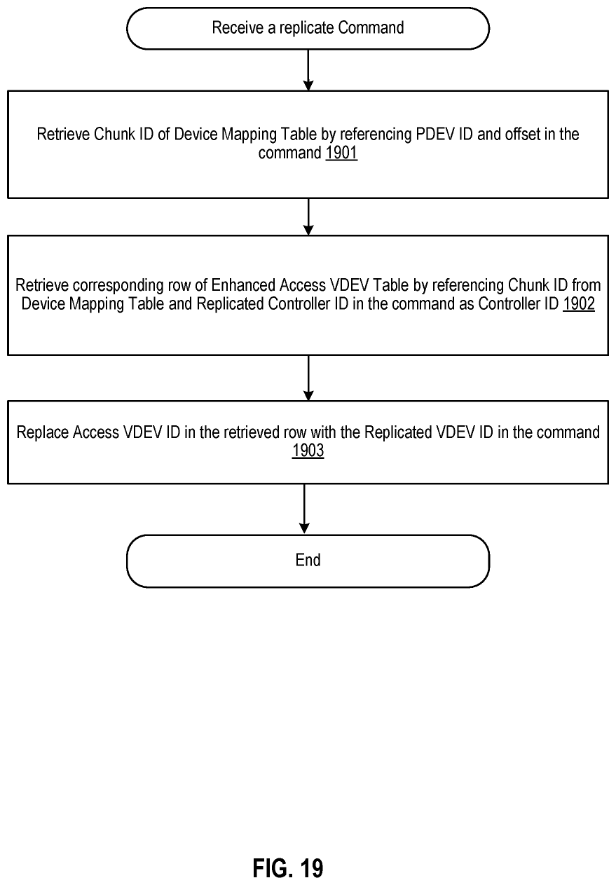

CPU 112 or CPU 122 can be configured to, for replication of the virtual device from the first controller to the second controller, determine the physical device associated with the virtual device from the plurality of physical devices; retrieve the access VDEV ID associated with the second controller for the physical device; and add to the mapping, another mapping between the replication VDEV ID, the physical device, and a controller identifier of the second controller, as illustrated in FIG. 18 and FIG. 19.

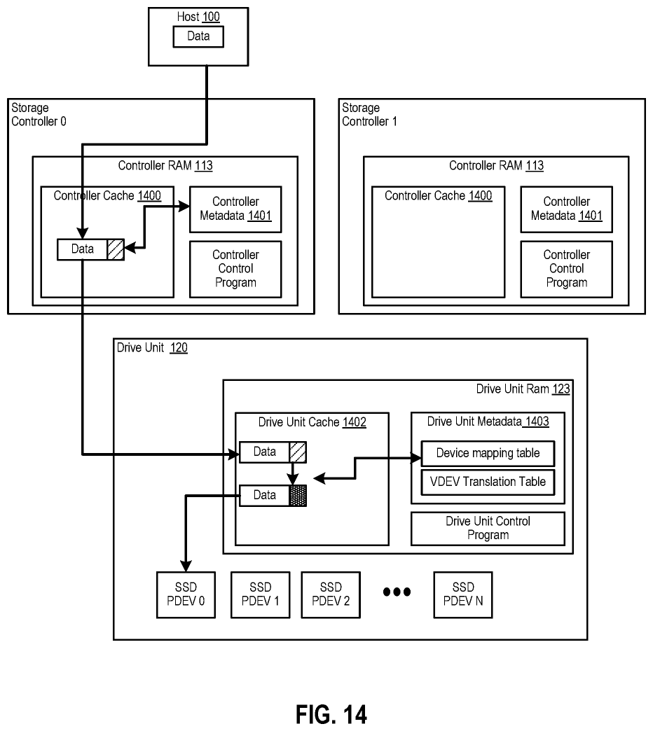

CPU 112 or CPU 122 can be configured to, for the data received from the first controller being a write data, cache the write data in a cache of the drive unit; modify the data integrity field of the write data in the cache with an identifier of the determined physical device to form modified write data; and write the modified write data from the cache to the determined physical device as illustrated in FIG. 14. In such an example implementation, the identifier of the determined physical device can include the write identifier.

CPU 112 or CPU 122 can be configured to, for the migration of the virtual device from the first controller to the second controller, for the VDEV ID indicated by the mapping as already being in use within the second controller, generating a new VDEV ID for the migration as illustrated in FIG. 13.

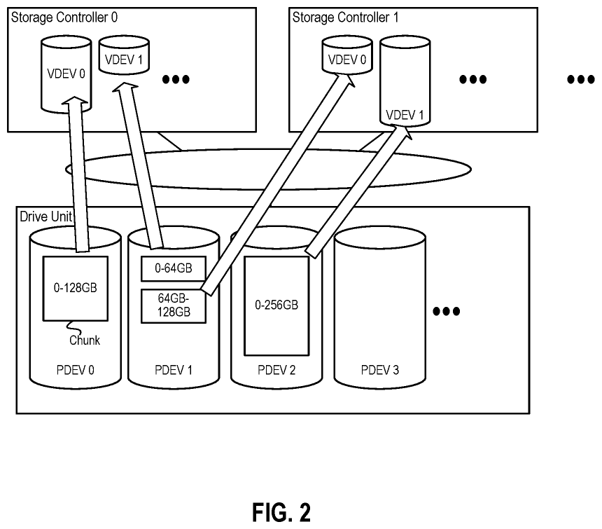

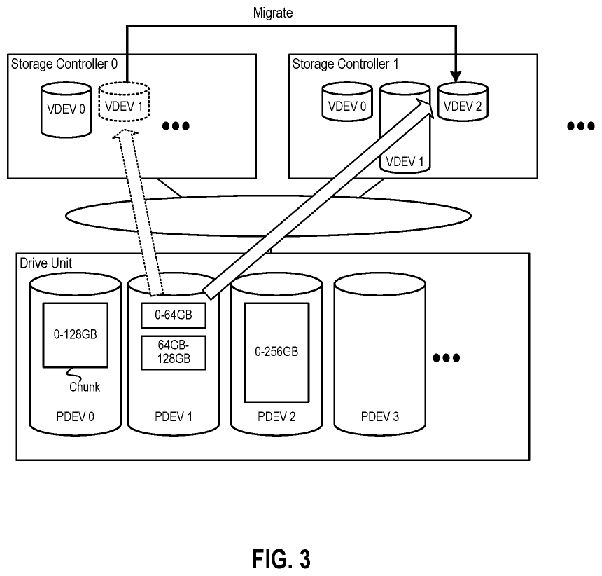

FIG. 2 illustrates a logical storage configuration of the computer system, in accordance with an example implementation. In the example implementation, the drive unit has a capability of providing at least a portion of PDEV capacity as a VDEV to the storage controllers. The storage controllers treat these VDEVs as a storage media. FIG. 3 illustrates an example logical storage configuration when metadata migration occurs from the state of FIG. 2. The figure shows that the VDEV 1 in the storage controller 0 is migrated as VDEV 2 in the storage controller 1 by moving the metadata related to the VDEV in the controller RAM 113.

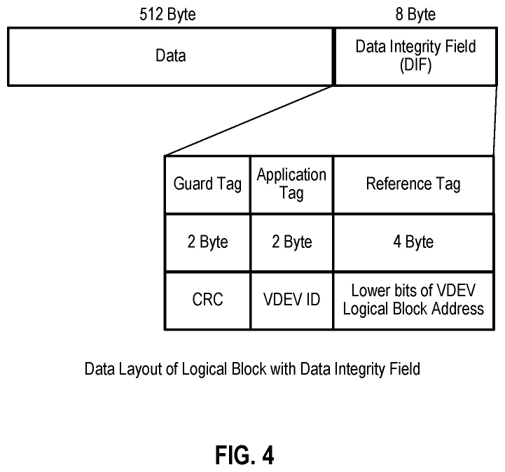

FIG. 4 illustrates a data layout of a logical block with Data Integrity Field, in accordance with an example implementation. The block can involve 512 bytes of user data and an 8-byte Data Integrity Field (DIF). DIF further involves 2 bytes of Guard Tag, 2 bytes of Application Tag and 4 bytes of Reference Tag. Generally, a Guard Tag is a 16-bit CRC (Cyclic Redundancy Check code) calculated from the user data, Application Tag is an application client specific information and Reference Tag is the lower 4-bytes of logical block address (LBA). In this example, assume that a storage controller stores a VDEV ID in the Application Tag and a lower 4-bytes of VDEV LBA in Reference Tag.

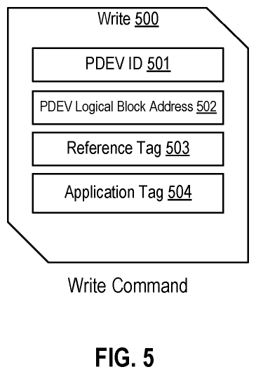

FIG. 5 illustrates a write command 500 sent from a storage controller to a drive unit, in accordance with an example implementation. The command includes PDEV ID 501 and PDEV Logical Block Address 502 to indicate which device and which address the corresponding data to be stored. The write command 500 also includes a Reference Tag 503 and an Application Tag 504 so that the drive unit (and the device) can check if these tags in the command and those of the corresponding data are the same. The command can include other information such as a pointer to data or a data size in accordance with the desired implementation.

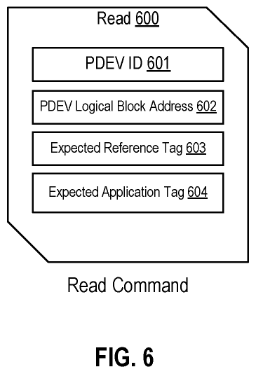

FIG. 6 illustrates a read command 600 sent from a storage controller to a drive unit, in accordance with an example implementation. The command 600 includes PDEV ID 601 and PDEV Logical Block Address 602 to indicate which device and from which address the corresponding data is to be retrieved. The read command 600 also includes an Expected Reference Tag 603 and an Expected Application Tag 604 so that the drive unit (and the drive) can check if these tags in the command and those of the corresponding data are the same. The command 600 can include other information such as a data size in accordance with the desired implementation.

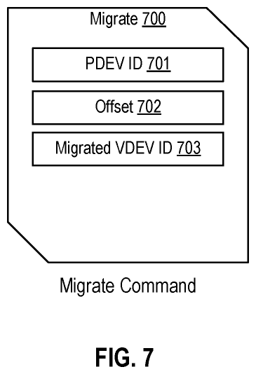

FIG. 7 illustrates a migrate command 700 sent from a storage controller to a drive unit, in accordance with an example implementation. This command 700 is sent to the drive unit to inform that a metadata migration occurs between storage controllers. The command 700 includes a PDEV ID 701 and a Offset 702 that show the migrated virtual device, and a migrated VDEV ID 703 that show a new identifier for the virtual device.

FIG. 8 illustrates an example of a device mapping table, in accordance with an example implementation. This table is managed by a drive unit and manages the mapping between each VDEV of a storage controller and the placement of the PDEV. The table is indexed by a PDEV ID, Offset and Size fields to retrieve Chunk ID. The PDEV ID field shows the PDEV for which the corresponding VDEV is placed. The offset field describes an offset of the PDEV for where the VDEV starts. The size field shows the size of the corresponding VDEV. The Chunk ID field shows an identifier of the corresponding chunk in the drive unit, and should be unique.

FIG. 9 illustrates an example of an access VDEV Table, in accordance with an example implementation. This table is managed by a drive unit and manages the mapping of the Chunk ID as shown in FIG. 8 and the corresponding VDEV ID.

FIG. 10 illustrates an example of a flow diagram in which a drive unit processes a write command 500 and its corresponding data from a storage controller in accordance with an example implementation. At 1001, the flow retrieves a Chunk ID from the Device Mapping Table of FIG. 8 by referencing the PDEV ID and PDEV Logical Block Address in the command 500. For the PDEV Logical Block Address, the flow searches for rows with PDEV Logical Block Address in the range of Offset to Offset+Size.

At 1002, the flow replaces the Application Tag (which is equal to VDEV ID as shown in FIG. 4) in the command 500 with the retrieved Chunk ID.

At 1003, the flow also replaces the Application Tag (=VDEV ID) in the data with the Chunk ID. Then, at 1004, the flow sends the command 500 and the data to the corresponding PDEV.

FIG. 11 illustrates an example of a flow diagram in which a drive unit processes a read command 600 from a storage controller, in accordance with an example implementation. At 1101, the flow retrieves a Chunk ID from the Device Mapping Table of FIG. 8 by referencing the PDEV ID and PDEV Logical Block Address in the command 600. For the PDEV Logical Block Address, the flow search for rows with PDEV Logical Block Address in the range of Offset to Offset+Size.

At 1102, the flow replaces the Expected Application Tag (=VDEV ID) in the command with the retrieved the Chunk ID.

At 1103, the flow sends the command to the corresponding PDEV.

FIG. 12 illustrates an example of a flow diagram when a drive unit receives a read data from a PDEV as a result of processing the flow described in FIG. 11, in accordance with an example implementation. At 1201, the flow retrieves a Chunk ID from the Device Mapping Table of FIG. 8 by referencing PDEV ID and PDEV Logical Block Address in the corresponding command 600. For the PDEV Logical Block Address, the flow search for rows with PDEV Logical Block Address in the range of Offset to Offset+Size.

At 1202, the flow retrieves an Access VDEV ID from the Access VDEV Table of FIG. 9 by referencing the retrieved Chunk ID. Then, at 1203 the flow replaces the Application Tag in the received data with the retrieved Access VDEV ID. Finally, at 1204, the flow sends the received data to the corresponding storage controller.

FIG. 13 illustrates an example of a flow diagram when a drive unit receives a migration command 700 from a storage controller, in accordance with an example implementation.

At 1301, the flow retrieves a Chunk ID from the Device Mapping Table by referencing the PDEV ID and the Offset in the corresponding command. At 1302, the flow retrieves a corresponding row from the Access VDEV Table by using the retrieved Chunk ID. At 1303, the flow replaces the Access VDEV ID in the retrieved row with the Migrated VDEV ID in the command.

FIG. 14 illustrates an example overview of a data write process, in accordance with an example implementation. In this example, a host write data to the storage controller 0 and the data is placed in the Controller Cache area 1400 in the Controller RAM 113. The storage controller 0 adds a DIF to the data to achieve end-to-end data protection, using VDEV ID and VDEV LBA stored in the Controller Metadata area 1401. Then, the storage controller sends a write command and data to the drive unit 120, which is stored in the drive unit cache 1402. The drive unit replaces DIF using the Device Mapping Table from the drive unit metadata 1403 and stores the data to corresponding PDEV.

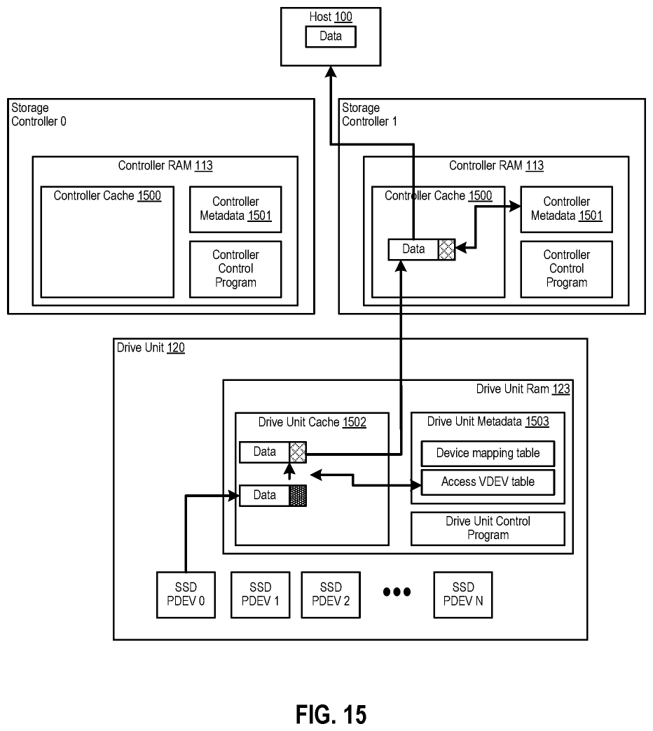

FIG. 15 illustrates an example overview of a data read process, in accordance with an example implementation. In this example, a host requests to read data through the storage controller 1. The drive unit 120 reads the corresponding data from the PDEV into the cache 1502 and replaces DIF by using the Access VDEV Table from the drive unit metadata 1503. Then, the drive unit 120 sends the data to the storage controller 1, which is stored in cache 1500. The storage controller 1 checks if the DIF is correct by using VDEV ID and VDEV LBA stored in the Controller Metadata area 1501. Finally, the storage controller sends data to the host 100.

In another example implementation, multiple storage controllers share a chunk of the PDEV by copying metadata. In such an example implementation, configurations without Access VDEV Table are the same as the previously described example implementations. The Access VDEV Table is replaced with Enhanced Access VDEV Table as shown in FIG. 17.

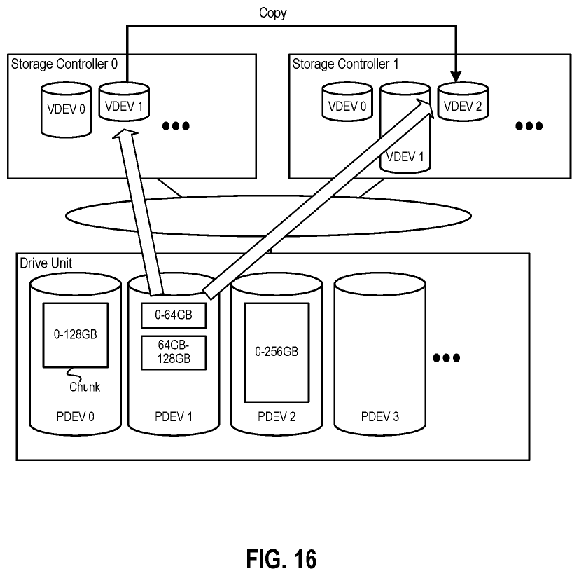

FIG. 16 illustrates a logical storage configuration when metadata copy occurs from the state of FIG. 2, in accordance with an example implementation. The figure shows that the VDEV 1 in the storage controller 0 is replicated to VDEV 2 in the storage controller 1 by copying the metadata.

FIG. 17 illustrates an example of an Enhanced Access VDEV Table, in accordance with an example implementation. The table is indexed by a Chunk ID and a Controller ID to retrieve the corresponding Access VDEV ID.

FIG. 18 illustrates an example of a replicate command, in accordance with an example implementation. The replicate command 1800 may involve the PDEV ID 1801, the Offset 1802, the Replicated Controller ID 1803, and the Replicated VDEV ID 1804. The elements of the replicate command are utilized in the manner shown in FIG. 19.

FIG. 19 illustrates an example of a flow diagram when a drive unit receives a replicate command from a storage controller, in accordance with an example implementation. At 1901, the flow retrieves a Chunk ID from the Device Mapping Table by referencing the PDEV ID 1801 and the Offset 1802 in the command. At 1902, the flow retrieves a corresponding row of the Enhanced Access VDEV Table by using the retrieved Chunk ID and the Replicated Controller ID 1803 in the command as the Controller ID. At 1903, the flow replaces the Access VDEV ID in the retrieved row with the Replicated VDEV ID 1804 in the command

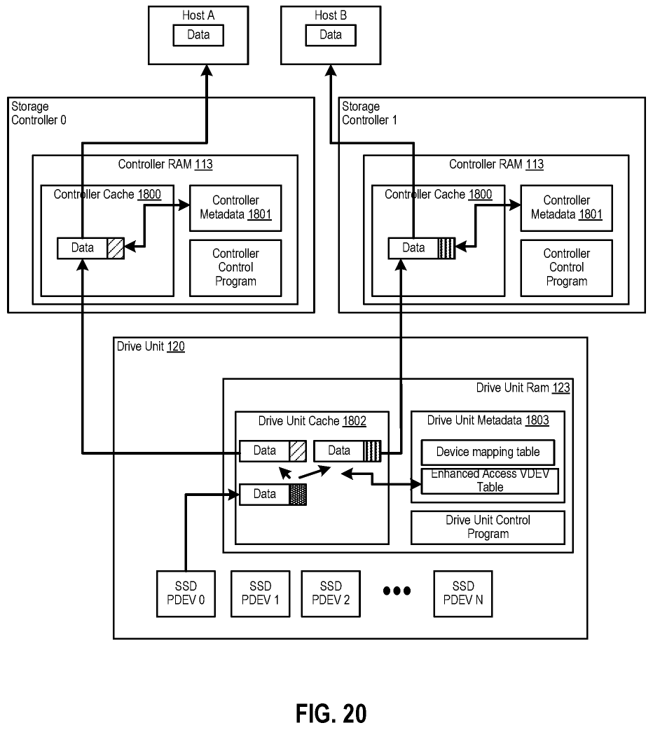

FIG. 20 shows an example overview of two data read processes, in accordance with an example implementation. In this example, Host A requests to read data through the storage controller 0 and Host B requests other data through the storage controller 1 but they retrieve the same data after all. The drive unit 120 reads the corresponding data from the PDEV into the Drive Unit Cache 1802 of the Drive Unit RAM 123 and replaces DIF using the Enhanced Access VDEV Table in the Drive Unit Metadata 1803. The replaced DIFs for the Storage Controller 0 and the Storage Controller 1 may differ, according to the corresponding VDEV IDs. Then, the drive unit 120 sends the data to the storage controller 0 and 1, respectively, for management in the respective controller cache 1800. Each storage controller checks if the DIF is correct using VDEV ID and VDEV LBA stored in the Controller Metadata area 1801. Finally, each storage controller sends data to the corresponding host.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. A computer-readable storage medium may involve tangible mediums such as, but not limited to optical disks, magnetic disks, read-only memories, random access memories, solid state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the techniques of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the techniques of the present application. Various aspects and/or components of the described example implementations may be used singly or in any combination. It is intended that the specification and example implementations be considered as examples only, with the true scope and spirit of the present application being indicated by the following claims.

What is claimed is:

1. A method, comprising:
managing a mapping between write identifier, access virtual device identifier, and physical device for a drive unit comprising a plurality of physical devices;
for migration of a virtual device from a first controller to a second controller:
retrieving a virtual device identifier from the second controller;
determining the physical device associated with the virtual device from the plurality of physical devices; and
updating, for the determined physical device, the access virtual device identifier with the virtual device identifier in the mapping;
wherein
a command received from the second controller to the determined physical device is processed through modification of one or more fields related to a data integrity field of the command based on the updated mapping; and
data received from the determined physical device to the second controller is processed through modification of the data integrity field of the data based on the updated mapping.

2. The method of claim 1, wherein the modification of the one or more fields related to the data integrity field based on the updated mapping comprises:
modifying the one or more fields related to the data integrity field of the command according to the write identifier to form a modified command; and
transmitting the modified command to the determined physical device.

3. The method of claim 1, wherein the modification of the data integrity field based on the updated mapping comprises:
modifying the data integrity field of received data directed to the second controller with the access virtual device identifier to form modified data; and
transmitting the modified data to the second controller.

4. The method of claim 1, further comprising, for replication of the virtual device from the first controller to the second controller:
determining the physical device associated with the virtual device from the plurality of physical devices;
retrieving the access virtual identifier associated with the second controller for the physical device;
adding to the mapping, another mapping between the virtual device identifier, the physical device, and a controller identifier of the second controller.

5. The method of claim 1, further comprising, for the data received from the first controller being a write data:
caching the write data in a cache of the drive unit;
modifying the data integrity field of the write data in the cache with an identifier of the determined physical device to form modified write data; and
writing the modified write data from the cache to the determined physical device.

6. The method of claim 5, wherein the identifier of the determined physical device comprises the write identifier.

7. The method of claim 1, further comprising, for the migration of the virtual device from the first controller to the second controller:
for the virtual device identifier indicated by the mapping as already being in use within the second controller, generating a new virtual device identifier for the migration.

8. A non-transitory computer readable medium, storing instructions for executing a process, the instructions comprising:
managing a mapping between write identifier, access virtual device identifier, and physical device for a drive unit comprising a plurality of physical devices;
for migration of a virtual device from a first controller to a second controller:
retrieving a virtual device identifier from the second controller;
determining the physical device associated with the virtual device from the plurality of physical devices; and
updating, for the determined physical device, the access virtual device identifier with the virtual device identifier in the mapping;
wherein
a command received from the second controller to the determined physical device is processed through modification of one or more fields related to a data integrity field of the command based on the updated mapping; and
data received from the determined physical device to the second controller is processed through modification of the data integrity field of the data based on the updated mapping.

9. The non-transitory computer readable medium of claim 8, wherein the modification of the one or more fields related to the data integrity field based on the updated mapping comprises:
modifying the one or more fields related to the data integrity field of the command according to the write identifier to form a modified command; and
transmitting the modified command to the determined physical device.

10. The non-transitory computer readable medium of claim 8, wherein the modification of the data integrity field based on the updated mapping comprises:
modifying the data integrity field of received data directed to the second controller with the access virtual device identifier to form modified data; and
transmitting the modified data to the second controller.

11. The non-transitory computer readable medium of claim 8, further comprising, for replication of the virtual device from the first controller to the second controller:
retrieving a virtual device identifier from the second controller;
determining the physical device associated with the virtual device from the plurality of physical devices;
adding to the mapping, another mapping between the virtual device identifier, the physical device, and a controller identifier of the second controller.

12. The non-transitory computer readable medium of claim 8, further comprising, for the data received from the first controller being a write data:
caching the write data in a cache of the drive unit;
modifying the data integrity field of the write data in the cache with an identifier of the determined physical device to form modified write data; and
writing the modified write data from the cache to the determined physical device.

13. The non-transitory computer readable medium of claim 12, wherein the identifier of the determined physical device comprises the write identifier.

14. The non-transitory computer readable medium of claim 8, further comprising, for the migration of the virtual device from the first controller to the second controller:
for the virtual device identifier indicated by the mapping as already being in use within the second controller, generating a new virtual device identifier for the migration.

15. An apparatus, comprising:
a memory configured to manage a mapping between write identifier, access virtual device identifier, and physical device for a drive unit comprising a plurality of physical devices; and
a processor, configured to:
for migration of a virtual device from a first controller to a second controller:
retrieve a virtual device identifier from the second controller;
determine the physical device associated with the virtual device from the plurality of physical devices; and
update, for the determined physical device, the access virtual device identifier with the virtual device identifier in the mapping;
wherein
a command received from the second controller to the determined physical device is processed through modification of one or more fields related to a data integrity field of the command based on the updated mapping; and
data received from the determined physical device to the second controller is processed through modification of the data integrity field of the data based on the updated mapping.

16. The apparatus of claim 15, wherein the processor is configured to modify the one or more fields related to the data integrity field based on the updated mapping by:
modifying the one or more fields related to the data integrity field of the command according to the write identifier to form a modified command; and
transmitting the modified command to the determined physical device.

17. The apparatus of claim 15, wherein the processor is configured to modify the data integrity field based on the updated mapping by:
modifying the data integrity field of received data directed to the second controller with the access virtual device identifier to form modified data; and
transmitting the modified data to the second controller.

18. The apparatus of claim 15, the processor further configured to, for replication of the virtual device from the first controller to the second controller:
retrieve a virtual device identifier from the second controller;
determine the physical device associated with the virtual device from the plurality of physical devices;
add to the mapping, another mapping between the virtual device identifier, the physical device, and a controller identifier of the second controller.

19. The apparatus of claim 15, the processor further configured to, for the data received from the first controller being a write data:
cache the write data in a cache of the drive unit;
modify the data integrity field of the write data in the cache with an identifier of the determined physical device to form modified write data; and
write the modified write data from the cache to the determined physical device.

20. The apparatus of claim 19, wherein the identifier of the determined physical device comprises the write identifier.

21. The apparatus of claim 15, further comprising, for the migration of the virtual device from the first controller to the second controller:
for the virtual device identifier indicated by the mapping as already being in use within the second controller, generating a new virtual device identifier for the migration.
